(19) United States
(12) Patent Application Publication
(10) Pub. No.: US 2026/0204637 A1
(43) Pub. Date: Jul. 16, 2026

(54) POLYMER SOLID ELECTROLYTE AND ALL-SOLID-STATE BATTERY COMPRISING SAME

(71) Applicant: DAEGU GYEONGBUK INSTITUTE OF SCIENCE AND TECHNOLOGY, Daegu (KR)

(72) Inventors: Jae Hyeon KIM, Daegu (KR); Eunhui KIM, Pohang-si Gyeongsangbuk-do (KR); Jamal HASAN, Daegu (KR); Injun JEON, Daegu (KR)

(21) Appl. No.: 19/468,140

(22) Filed: Feb. 3, 2026

Related U.S. Application Data
(63) Continuation of application No. PCT/KR2024/010246, filed on Jul. 17, 2024.

(30) Foreign Application Priority Data
Aug. 3, 2023 (KR) 10-2023-0101434

(51) Int. Cl. H01M 10/0565; H01M 4/02; H01M 4/38

(52) U.S. Cl. CPC H01M 10/0565; H01M 4/382; H01M 2004/027; H01M 2300/0082

(57) ABSTRACT

The present invention relates to a polymer solid electrolyte comprising an ion-conductive polymer, an organic ionic plastic crystal containing imidazolium, and a lithium salt. The polymer solid electrolyte according to an embodiment is capable of simultaneously achieving excellent ionic conductivity and electrochemical stability.

### CROSS-REFERENCE TO RELATED APPLICATION

This application is a continuation of International Application No. PCT/KR2024/010246, filed Jul. 17, 2024, which is based upon and claims priority to Korean Patent Application No. 10-2023-0101434 filed on Aug. 3, 2023. The aforementioned applications are hereby incorporated by reference in their entireties.

### TECHNICAL FIELD

The present disclosure relates to a polymer solid electrolyte and an all-solid-state battery including the same.

### BACKGROUND ART

Recently, as the development of lithium batteries having simultaneously improved energy density and safety is required, all-solid-state batteries using a solid electrolyte, which have a low risk of ignition, do not cause electrolyte leakage issues, and do not require a separator, have attracted attention as next-generation batteries.

A solid electrolyte may be classified into a polymer solid electrolyte and an inorganic solid electrolyte depending on its material, and the polymer solid electrolyte also has advantageous features in terms of flexibility, light weight, and processability. However, the polymer solid electrolyte has a problem in that ionic conductivity, lithium-ion yield, and the like are low as compared to conventional liquid electrolytes and inorganic solid electrolytes. In order to solve these problems, various strategies, such as introducing an inorganic filler and a metal-organic framework, have been devised, but it is still difficult to achieve an ionic conductivity at a level required for commercialization.

### DISCLOSURE

### Technical Problem

An aspect of the present invention is to provide a polymer solid electrolyte capable of simultaneously achieving excellent ionic conductivity and electrochemical stability, and a method for preparing the same.

Another aspect of the present invention is to provide an all-solid-state battery including the polymer solid electrolyte.

### Technical Solution

In one general aspect, a polymer solid electrolyte includes an ion-conductive polymer, an organic ionic plastic crystal containing imidazolium, and a lithium salt.

The organic ionic plastic crystal containing imidazolium may be in a solid state at room temperature.

The organic ionic plastic crystal may be represented by the following Chemical Formula 1.

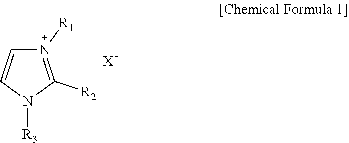

(In Chemical Formula 1,
R₁ to R₃ are each independently (C1-C7) alkyl, and
X⁻ is Cl⁻, Br⁻, I⁻, BF₄⁻, or PF₆⁻.)

The organic ionic plastic crystal may be represented by the following Chemical Formula 1-1.

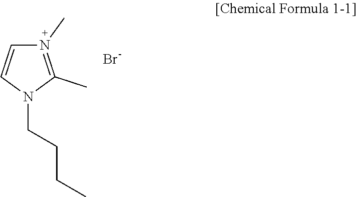

The organic ionic plastic crystal may be included in an amount of 0.5 to 5 parts by weight based on 100 parts by weight of the ion-conductive polymer.

The lithium salt and the organic ionic plastic crystal may be included at a weight ratio of 1:0.1 to 1.

The ion-conductive polymer may be a polyalkylene oxide-based polymer.

The lithium salt may include an imide-based anion.

In another general aspect, an all-solid-state battery includes a positive electrode, the polymer solid electrolyte, and a negative electrode.

The negative electrode may include a negative electrode current collector and a negative electrode active material layer.

In still another general aspect, a method for preparing a polymer solid electrolyte includes: (A) mixing an organic ionic plastic crystal containing imidazolium and a lithium salt in an organic solvent to prepare a mixed solution; (B) adding an ion-conductive polymer to the mixed solution and performing mixing to prepare a polymer solid electrolyte slurry; and (C) applying the polymer solid electrolyte slurry to a substrate, drying the applied slurry, and applying heat to obtain the polymer solid electrolyte.

### Advantageous Effects

An all-solid-state battery employing the polymer solid electrolyte according to an embodiment of the present invention may satisfy both excellent battery performance and lifespan characteristics.

Specifically, the polymer solid electrolyte according to an embodiment may achieve an ionic conductivity at a level required for commercialization, for example, a significantly excellent ionic conductivity of 1.0×10⁻³ or more at room temperature. In addition, the polymer solid electrolyte according to an embodiment has excellent stability and excellent compatibility with a lithium metal negative electrode, and an all-solid-state battery employing the polymer solid electrolyte according to an embodiment and a lithium metal negative electrode has excellent lifespan characteristics, with a capacity retention of 99.7% or more even after 300 cycles. Furthermore, the polymer solid electrolyte according to an embodiment not only has excellent ionic conductivity and stability but may also ensure flexibility, and thus has an advantage of being applicable to a flexible device.

### DESCRIPTION OF DRAWINGS

FIG. 1 illustrates analysis results of lifespan characteristics of an all-solid-state battery according to Example 2.

### BEST MODE

Unless otherwise defined, all the technical terms and scientific terms used in the present specification have the same meanings as commonly understood by those skilled in the art to which the present invention pertains. The terms used in the present specification are merely used to effectively describe a specific embodiment, but are not intended to limit the present invention.

Unless the context clearly indicates otherwise, singular forms used in the present specification may be intended to include plural forms.

Throughout the present specification, unless explicitly described to the contrary, “comprising”, “including”, “containing”, or “having” any components will be understood to imply further inclusion of other components rather than the exclusion of any other components, and does not exclude elements, materials, or processes which are not further listed.

A numerical range used in the present specification includes upper and lower limits and all values within these limits, increments logically derived from a form and span of a defined range, all doubly limited values, and all possible combinations of the upper and lower limits in the numerical range defined in different forms. Unless otherwise specifically defined in the present specification, values out of the numerical range that may occur due to experimental errors or rounded values also fall within the defined numerical range.

In the present specification, unless otherwise specifically defined, “about” may be considered to indicate a value within 30%, 25%, 20%, 15%, 10%, or 5% of a stated value.

Hereinafter, the present disclosure will be described in detail. However, the description is merely illustrative and the present disclosure is not to be construed as being limited to the specific embodiments described by way of example.

An aspect of the present invention provides a polymer solid electrolyte capable of achieving excellent ionic conductivity and electrochemical stability.

Specifically, the polymer solid electrolyte according to an embodiment may include an ion-conductive polymer, an organic ionic plastic crystal containing imidazolium, and a lithium salt.

Here, the organic ionic plastic crystal (OIPC) refers to an ionic organic compound that is in a solid phase having a plastic crystal at room temperature (25° C.), exhibits remarkably soft characteristics in the solid phase, and undergoes a solid-solid phase transition in which a crystal phase changes when the temperature changes below the melting point.

The organic ionic plastic crystal containing imidazolium may include an imidazolium cation and a counter anion. The counter anion is not limited as long as it binds to the imidazolium cation to allow the plastic crystal to be in a solid state at room temperature, and may be, for example, Cl⁻, Br⁻, I⁻, BF₄⁻, or PF₆⁻.

A melting point (Tₘ) of the organic ionic plastic crystal containing imidazolium may be 100° C. or higher, 150° C. or higher, 100° C. to 300° C., 150° C. to 300° C., or 200° C. to 300° C.

Specifically, the organic ionic plastic crystal may be represented by the following Chemical Formula 1.

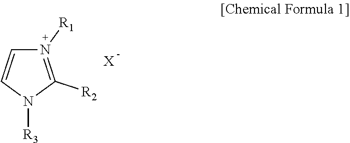

(In Chemical Formula 1,
R₁ to R₃ are each independently (C1-C7) alkyl, and
X⁻ is Cl⁻, Br⁻, I⁻, BF₄⁻, or PF₆⁻.)

For example, R₁ and R₂ may each independently be (C1-C4) alkyl, methyl, or ethyl.

For example, R₁ and R₂ may be identical to each other and may be (C1-C4) alkyl, methyl, or ethyl.

The organic ionic plastic crystal may be, for example, represented by the following Chemical Formula 1-1.

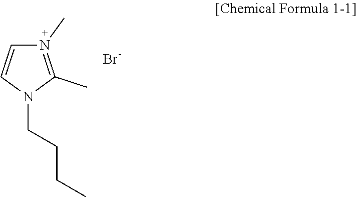

The organic ionic plastic crystal may be included in an amount of 0.5 parts by weight or more, 1 part by weight or more, or 1.5 parts by weight or more, and 10 parts by weight or less or 5 parts by weight or less, based on 100 parts by weight of the ion-conductive polymer; specifically, the organic ionic plastic crystal may be included in an amount of 0.5 to 5 parts by weight, 1 to 5 parts by weight, or 1 to 3 parts by weight. The numerical ranges may include all possible combinations of upper limits and lower limits. When the content satisfies the above numerical ranges, ionic conductivity and stability of a polymer solid separator that is subsequently obtained may be further improved.

The lithium salt and the organic ionic plastic crystal may be included at a weight ratio of 1:0.1 to 1, 1:0.1 to 0.8, or 1:0.1 to 0.5.

The ion-conductive polymer is not particularly limited as long as it is commonly used in the art, and may be, for example, a polyalkylene oxide-based polymer. Specifically, as non-limiting examples, the polyalkylene oxide-based polymer may be selected from the group consisting of polyethylene oxide, polypropylene oxide, polybutylene oxide, a polyethylene oxide-polypropylene oxide blend, a polyethylene oxide-polybutylene oxide blend, a polyethylene oxide-polypropylene oxide-polybutylene oxide blend, a polyethylene oxide-polypropylene oxide block copolymer, a polyethylene oxide-polybutylene oxide block copolymer, a polyethylene oxide-polypropylene oxide-polybutylene oxide block copolymer, a polybutylene oxide-polyethylene oxide-polybutylene oxide block copolymer, a polyethylene oxide-polybutylene oxide-polyethylene oxide block copolymer, polyethylene oxide-grafted polymethyl methacrylate (PEO-grafted PMMA), polypropylene oxide-grafted polymethyl methacrylate (PPO-grafted PMMA), and polybutylene oxide-grafted polymethyl methacrylate (PBO-grafted PMMA).

The ion-conductive polymer may be a linear polymer, a branched polymer, or a network polymer. Specifically, the ion-conductive polymer may be a linear polymer, and more preferably may be a linear polyethylene oxide (PEO) polymer.

The ion-conductive polymer may have a weight average molecular weight of 300,000 g/mol to 1,000,000 g/mol or 400,000 g/mol to 1,000,000 g/mol.

The lithium salt is not particularly limited as long as it is commonly used in the art, and may be, for example, one or two or more selected from LiSCN, LiN(CN)₂, Li(CF₃SO₂)₃C, LiC₄F₉SO₃, LiPF₃(C₂F₅)₃, LiCF₃SO₃, LiAsF₆, LiSbF₆, LiClO₄, LiCl, LiF, LiBr, LiI, LiB(C₂O₄)₂, LiPF₆, LiPF₅(CF₃), LiPF₅(C₂F₅), LiPF₅(C₃F₇), LiPF₄(CF₃)₂, LiPF₄(CF₃)(C₂F₅), LiPF₃(CF₃)₃, LiPF₃(CF₂CF₃)₃, LiPF₄(C₂O₄)₂, LiBF₄, LiBF₃ (C₂F₅), lithium bis(oxalato)borate (LiBOB), lithium oxalyldifluoroborate (LIODFB), lithium difluoro(oxalato)borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), and LiN(SO₂C₂F₅)₂.

Specifically, the lithium salt may include an imide-based anion, and may be, for example, one or two or more selected from lithium bis(trifluoromethanesulfonyl)imide (LiTFSI, LiN(SO₂CF₃)₂), lithium bis(fluorosulfonyl)imide (LiFSI, LiN(SO₂F)₂), and LiN(SO₂C₂F₅)₂. More specifically, the lithium salt may be LiTFSI.

The polymer solid electrolyte according to an embodiment may be prepared by a method including: (A) mixing an organic ionic plastic crystal containing imidazolium and a lithium salt in an organic solvent to prepare a mixed solution; (B) adding an ion-conductive polymer to the mixed solution and performing mixing to prepare a polymer solid electrolyte slurry; and (C) applying the polymer solid electrolyte slurry to a substrate, drying the applied slurry, and applying heat to obtain the polymer solid electrolyte.

Another aspect of the present invention provides an all-solid-state battery including the polymer solid electrolyte.

Hereinafter, an all-solid-state battery according to an embodiment will be described, and except for including the polymer solid electrolyte according to an embodiment, the all-solid-state battery may be manufactured in a structure known in the art using conventional manufacturing methods and materials.

The all-solid-state battery according to an embodiment may include a positive electrode, a solid electrolyte, and a negative electrode. The solid electrolyte may include the polymer solid electrolyte according to an embodiment, and the polymer solid electrolyte may have a thickness of 10 to 200 μm, 30 to 200 μm, or 50 to 200 μm.

The positive electrode may include a positive electrode current collector and a positive electrode active material layer formed on the positive electrode current collector.

Non-limiting examples of the positive electrode current collector include a foil formed of aluminum, nickel, or a combination thereof, and the positive electrode active material layer may include a positive electrode active material and, if necessary, a binder, a conductive agent, a dispersant, and the like.

The positive electrode active material may be a conventional positive electrode active material used in the art. Non-limiting examples of the positive electrode active material include lithium cobalt composite oxide (LiCoO₂), spinel-type lithium manganese composite oxide (LiMn₂O₄), lithium manganese composite oxide (LiMnO₂), lithium nickel composite oxide (LiNiO₂), lithium iron phosphate (LiFePO₄; LFP), lithium manganese phosphate (LiMnPO₄), lithium cobalt phosphate (LiCoPO₄), lithium iron pyrophosphate (Li₂FeP₂O₇), lithium niobium composite oxide (LiNbO₂), lithium iron composite oxide (LiFeO₂), lithium magnesium composite oxide (LiMgO₂), lithium copper composite oxide (LiCuO₂), lithium zinc composite oxide (LiZnO₂), lithium molybdenum composite oxide (LiMoO₂), lithium tantalum composite oxide (LiTaO₂), lithium tungsten composite oxide (LiWO₂), lithium-rich manganese-rich nickel cobalt composite oxide (xLi₂MnO₃ (1-x)LiMn_{1-y-z}Ni_{y}Co_{z}O₂), lithium nickel cobalt aluminum composite oxide (LiNi_{0.8}Co_{0.15}Al_{0.05}O₂), lithium nickel cobalt manganese composite oxides (LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), and lithium nickel manganese oxide (LiNi_{0.5}Mn_{1.5}O₄). Specifically, lithium iron phosphate may be used, but the positive electrode active material is not limited thereto.

As the conductive agent, carbon black such as carbon black, acetylene black, Ketjen black, channel black, furnace black, lamp black, and thermal black; conductive fibers such as carbon fibers and metal fibers; metal powders such as carbon fluoride, aluminum, and nickel powder; conductive whiskers such as zinc oxide and potassium titanate; conductive metal oxides such as titanium oxide; and conductive materials such as polyphenylene derivatives may be used, but the conductive agent is not particularly limited as long as it has conductivity without causing a chemical change in the battery.

The binder polymer may include one or two or more selected from the group consisting of nitrile butadiene rubber, polybutadiene rubber, polyethylene glycol, polyacrylonitrile, polyvinyl chloride, polymethyl methacrylate, polypropylene oxide, polydimethylsiloxane, polyvinylidene fluoride, polyvinylidene carbonate, and polyvinylpyrrolidone.

The negative electrode may include a negative electrode current collector and a negative electrode active material layer formed on the negative electrode current collector.

As non-limiting examples, the negative electrode current collector may be selected from foils formed of copper, gold, nickel, a copper alloy, or a combination thereof. The negative electrode active material layer may be one or two or more selected from the group consisting of a carbon selected from soft carbon, hard carbon, artificial graphite, natural graphite, expanded graphite, carbon fibers, non-graphitizable carbon, carbon black, carbon nanotubes, acetylene black, Ketjen black, graphene, fullerene, activated carbon, and mesocarbon microbeads; a metal selected from silicon, tin, lithium, aluminum, silver, bismuth, indium, germanium, lead, platinum, titanium, zinc, manganese, cadmium, selenium, copper, cobalt, nickel, and iron; an alloy including two or more of the metals; and an oxide of one or more of the metals. Preferably, the negative electrode active material layer may be lithium metal, but is not limited thereto.

A lithium metal negative electrode may satisfy a high energy density due to a high specific capacity and a low reduction potential. However, in a battery employing lithium metal as a negative electrode, dendritic growth (dendrite) occurred on an electrode surface during charging and discharging, and deterioration of reversible capacity was accelerated. The polymer solid electrolyte according to an embodiment has excellent compatibility with lithium metal and may achieve excellent lifespan characteristics when lithium metal is employed as a negative electrode, thereby solving the above-described problems of the related art.

Hereinafter, the embodiments described above will be described in more detail with reference to Examples. However, the following Examples are provided merely for illustrative purposes and are not intended to limit the scope of the present invention.

### Example 1

### Preparation of Polymer Solid Electrolyte

0.39 g of lithium bis(trifluoromethanesulfonyl)imide (LiTFSI) and 0.0495 g of 1-butyl-2,3-dimethylimidazolium bromide (BMI-Br, Chemical Formula 1-1) were added to 15 mL of acetonitrile (ACN) and stirred at room temperature (25° C.) for 2 hours, 0.60 g of polyethylene oxide (PEO, M, =600,000 g/mol) was added, and the resulting mixture was further stirred for 24 hours, thereby preparing a polymer solid electrolyte slurry. Thereafter, the polymer solid electrolyte slurry was applied to a Teflon dish, dried in a glove box for 24 hours, and then heated at 60° C. for 12 hours using a hot plate, thereby obtaining a polymer solid electrolyte having a thickness of 108 μm.

### Manufacture of All-Solid-State Battery

A positive electrode material slurry was prepared by adding lithium iron phosphate (LiFePO₄, LFP)/carbon nanotubes/polyvinylidene fluoride (PVDF)/LiTFSI/PEO to N-methylpyrrolidone so that a weight ratio of the materials was 75:8:1:4:3:9 and a content of the positive electrode material was 75%. The positive electrode material slurry was applied, using a doctor blade, to a carbon (C)-coated aluminum (Al) thin film having a thickness of 17 μm, hot-air dried at 90° C. for 2 hours, and then vacuum dried at 70° C. for 12 hours, thereby obtaining a positive electrode in which a positive electrode active material layer having a thickness of 30 μm was formed. An all-solid-state battery was manufactured by stacking the polymer solid electrolyte sheet between the positive electrode obtained above and a lithium metal negative electrode having a thickness of 50 μm.

### Examples 2 to 4

The procedures were performed in the same manner as in Example 1, except that, in the preparation of the polymer solid electrolyte, the amount of BMI-Br was changed to 0.099 g (Example 2), 0.1485 g (Example 3), and 0.198 g (Example 4).

### Comparative Example 1

The procedure was performed in the same manner as in Example 1, except that BMI-Br was not added in the preparation of the polymer solid electrolyte.

### Comparative Example 2

The procedure was performed in the same manner as in Example 1, except that, in the preparation of the polymer solid electrolyte, N,N-diethylpyrrolidinium bis(trifluorosulfonyl)imide (C₂epyr-FSI) was used instead of BMI-Br.

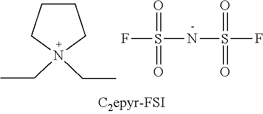

### Comparative Example 3

The procedure was performed in the same manner as in Example 1, except that, in the preparation of the polymer solid electrolyte, an ionic liquid, 1-butyl-2,3-dimethylimidazolium bis(trifluoromethanesulfonyl)imide (BMI-TFSI), was used instead of BMI-Br.

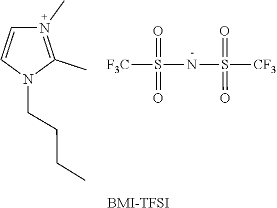

### Evaluation Examples

### Evaluation 1. Evaluation of Ionic Conductivity of Polymer Solid Electrolyte

Ionic conductivity measurement cells were manufactured by placing the polymer solid electrolytes prepared in the Examples and Comparative Examples between stainless steel, and ionic conductivity of the polymer solid electrolytes at each of the temperatures (30° C., 40° C., 50° C., 60° C., and 70° C.) was measured. Based on electrochemical impedance spectroscopy (EIS) analysis, impedance was measured at each of the temperature conditions by applying an AC amplitude of 5 mV in a frequency range of 50 mHz to 2 MHz, and ionic conductivity at each temperature was calculated. The results are shown in Table 1.

TABLE 1

| | Ionic conductivity (S/cm) | | | | |
|---|---|---|---|---|---|
| | 30° C. | 40° C. | 50° C. | 60° C. | 70° C. |
| Example 1 | 1.10 × 10⁻³ | 2.88 × 10⁻³ | 8.10 × 10⁻³ | 8.19 × 10⁻³ | 1.01 × 10⁻² |
| Example 2 | 2.34 × 10⁻³ | 4.10 × 10⁻³ | 1.35 × 10⁻² | 1.35 × 10⁻² | 1.34 × 10⁻² |
| Example 3 | 1.66 × 10⁻³ | 3.16 × 10⁻³ | 1.48 × 10⁻² | 1.07 × 10⁻² | 9.66 × 10⁻³ |
| Example 4 | 1.04 × 10⁻³ | 2.80 × 10⁻³ | 1.24 × 10⁻² | 1.20 × 10⁻² | 9.72 × 10⁻³ |
| Comparative | 1.97 × 10⁻⁵ | 7.37 × 10⁻⁵ | 1.56 × 10⁻⁴ | 3.95 × 10⁻⁴ | 5.53 × 10⁻⁴ |
| Example 1 | | | | | |

Referring to Table 1, it can be seen that the polymer solid electrolytes of Examples 1 to 4 exhibited an ionic conductivity about 100 times or more higher than that of the solid electrolyte of Comparative Example 1 in which BMI-Br was not introduced. In addition, it was confirmed that Comparative Examples 2 and 3 exhibited significantly lower ionic conductivity than the polymer solid electrolytes of the Examples, although the ionic compounds similar to BMI-Br of the Examples were used.

### Evaluation 2. Evaluation of Lifespan Characteristics

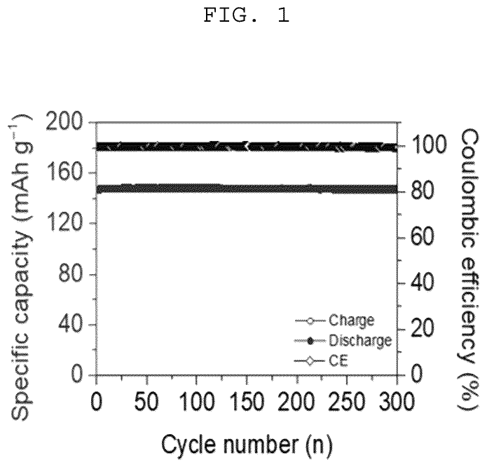

The lifespan characteristics of the all-solid-state batteries manufactured in Example 2 and Comparative Examples 2 and 3 were analyzed. Under a temperature condition of 60° C., an initial discharge capacity (C1) was observed at a current of 1 C (=1 mA/cm²) in a voltage range of 2.5 to 3.8 V, charging and discharging were repeated 300 times at a current of 1 C (=1 mA/cm²), a discharge capacity (C2) at the 300th cycle was measured, and a capacity retention (C2/C1×100) was calculated to evaluate lifespan characteristics. The results are shown in FIG. 1 and Table 2.

TABLE 2

| | Capacity retention |
|---|---|
| Example 2 | 99.7% |
| Comparative Example 2 | 90.6% |
| Comparative Example 3 | 86.2% (@150 cycle) |

As shown in FIG. 1 and Table 2, it was confirmed that the all-solid-state battery according to Example 2 had a capacity retention of 99.7% even after 300 cycles under a temperature condition of 60° C., indicating significantly excellent lifespan characteristics. In contrast, it can be seen that Comparative Examples 2 and 3 exhibited significantly deteriorated lifespan characteristics as compared to the all-solid-state batteries of the Examples, although the ionic compounds of Comparative Examples 2 and 3 were used. In particular, Comparative Example 3, in which an ionic compound of an ionic liquid was used instead of the organic ionic plastic crystal, exhibited a capacity retention of 85.2% even at 150 cycles, and thus the lifespan characteristics were significantly deteriorated as compared to the all-solid-state battery according to an embodiment of the present invention.

In summary, it can be seen that the polymer solid electrolyte according to an embodiment of the present invention may sufficiently achieve an ionic conductivity at a level required for commercialization and has excellent compatibility with a lithium metal negative electrode; therefore, lifespan characteristics are significantly excellent even when lithium metal is used as a negative electrode.

Although the present invention has been described above with reference to limited embodiments, the embodiments are provided only to assist in a more general understanding of the present invention. Accordingly, the present invention is not limited to the above embodiments, and various modifications and variations may be made from these descriptions by those skilled in the art to which the present invention pertains.

Therefore, the spirit of the present invention should not be limited to the described embodiments, but the claims and all modifications equal or equivalent to the claims are intended to fall within the scope of the spirit of the present invention.

1. A polymer solid electrolyte comprising an ion-conductive polymer, an organic ionic plastic crystal containing imidazolium, and a lithium salt.

2. The polymer solid electrolyte of claim 1, wherein the organic ionic plastic crystal containing imidazolium is in a solid state at room temperature.

3. The polymer solid electrolyte of claim 2, wherein the organic ionic plastic crystal is represented by the following Chemical Formula 1: 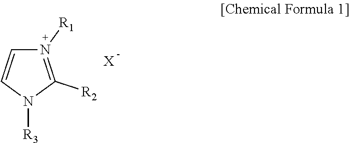
in Chemical Formula 1,
R₁ to R₃ are each independently (C1-C7) alkyl, and
X⁻ is Cl⁻, Br⁻, I⁻, BF₄⁻, or PF₆⁻.

4. The polymer solid electrolyte of claim 3, wherein the organic ionic plastic crystal is represented by the following Chemical Formula 1-1:

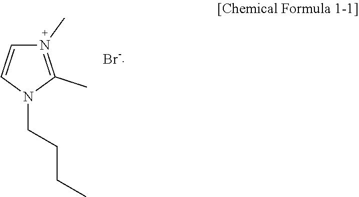

5. The polymer solid electrolyte of claim 1, wherein the organic ionic plastic crystal is included in an amount of 0.5 to 5 parts by weight based on 100 parts by weight of the ion-conductive polymer.

6. The polymer solid electrolyte of claim 1, wherein the lithium salt and the organic ionic plastic crystal are included at a weight ratio of 1:0.1 to 1.

7. The polymer solid electrolyte of claim 1, wherein the ion-conductive polymer is a polyalkylene oxide-based polymer.

8. The polymer solid electrolyte of claim 1, wherein the lithium salt includes an imide-based anion.

9. An all-solid-state battery comprising a positive electrode, the polymer solid electrolyte of claim 1, and a negative electrode.

10. The all-solid-state battery of claim 9, wherein the negative electrode includes a negative electrode current collector and a negative electrode active material layer, and the negative electrode active material layer is lithium metal.

11. A method for preparing a polymer solid electrolyte, the method comprising:
(A) mixing an organic ionic plastic crystal containing imidazolium and a lithium salt in an organic solvent to prepare a mixed solution;
(B) adding an ion-conductive polymer to the mixed solution and performing mixing to prepare a polymer solid electrolyte slurry; and
(C) applying the polymer solid electrolyte slurry to a substrate, drying the applied slurry, and applying heat to obtain the polymer solid electrolyte.
